(19) United States
(12) Patent Application Publication
(10) Pub. No.: US 2012/0093997 A1
(43) Pub. Date: Apr. 19, 2012

(54) PROCESS FOR MAKING CHOPPED OR CREAMED GARLIC AND CHOPPED OR CREAMED GARLIC SO OBTAINED SPECIFICATION

(75) Inventor: Stefano Cerasaro, Sissa (Parma) (IT)

(73) Assignee: SOCIETA' AGRICOLA CERASARO S.S., Sissa (Parma) (IT)

(21) Appl. No.: 13/378,095

(22) PCT Filed: Jun. 15, 2010
(86) PCT No.: PCT/IB10/52660

§ 371 Date: Dec. 14, 2011

(30) Foreign Application Priority Data
Jun. 16, 2009 (IT) PR2009A000047

(51) Int. Cl. A23L 1/39

(52) U.S. Cl. 426/589

(57) ABSTRACT

A process for obtaining chopped or creamed garlic, which includes the steps of: separating the bulbs of garlic into cloves, peeling the cloves and mixing and chopping them with vegetable oil, salt and citric acid. The process being a cold process, and involving no application of heat by pasteurization or boiling or heating of the garlic or the mixture so obtained.

### FIELD OF THE INVENTION

The present invention generally concerns food processing, namely the field of sauces and seasonings. The invention relates to a process for making chopped or creamed garlic and the chopped or creamed garlic so obtained.

### BACKGROUND OF THE INVENTION

Garlic is a bulbous cultivated plant of the family Liliaceae or Alliaceae.

It is primarily intended for seasoning and therapeutic uses.

Garlic is known to be creamed or chopped for use in lightly fried mixtures, sauces, grilled, toasted and fried bread, and as a seasoning for meats and fish. Many garlic cream recipes are currently available.

In one recipe, peeled garlic is first immersed in water or milk and boiled for a long time, so that it can be softened and pasteurized. After boiling, it is drained and pureed. With the addition of sour cream, a cream sauce is obtained. The latter is placed on the burner, and vegetable broth and potato starch are added with vigorous whipping.

In one variant of the basic recipe, unpeeled garlic gloves are wrapped in tin foil and baked at 90/100° C. for about 2 hours. After removal from the oven and cooling, the cloves are pressed one at the time to obtain a cream. The cream is collected in a bowl and further turned into puree, with the addition of Bechamel sauce, and everything is amalgamated and sifted.

Further variants include the addition of crumbs, cheese, butter, oil, salt and pepper, cream.

Milk (or water and Bechamel sauce) is typically added, in combination with a cooking action, to neutralize the unpleasant component of garlic.

The problem is that the garlic cream should have the same color as garlic, i.e. in most cases white: This requires a “bleaching” action, which is ensured by the heat that deactivates the enzymatic component.

In certain cases, once the milk has reached its boiling point, the burner is turned off and the operation is repeated several times, each time with some new milk.

The problem is that when garlic is submitted to heat treatment, allin and allicin, that are responsible for a number of its beneficial properties, are totally degraded. Thus, the white garlic-based cream so obtained has considerably impaired organoleptical properties.

Non-pasteurized garlic-based preparations are already available in the art, but they do not have the typical ivory white color, but a more or less vivid green. The basic problem is that as the pH is decreased below 5 (which is required to ensure microbiological stability), a change occurs in the enzymatic activity, which causes oxidation of allin and of certain phenolic compounds which, at microscopic level, cause the color to change from white to green.

WO96/07334 discloses a garlic cream were peeled of their outer membranes and chopped in a kitchen food processor for 2 minutes with the following ingredients, % by weight Garlic 70.5, Salt 9.5, Whey powder 9.5, Ascorbic acid 0.2, Citric acid 0.3, Sunflower oil 10.0

Drawbacks for the aforesaid prior art concern the quantity of salt and acid citric in the cream.

Further drawbacks of prior art preparations lie in that they all require refrigerated preservation, or anyway below 8° C., because they would not maintain their organoleptic properties.

### SUMMARY AND ADVANTAGES OF THE INVENTION

The object of the present invention is to provide a creamed or chopped garlic product that can maintain the organoleptic properties of garlic by a preparation process that includes no heat treatment.

Therefore, its advantages include the provision of a cream that has the characteristic color of garlic, as well as a stable behavior with time, even without pasteurization/boiling or heating of garlic.

These objects and advantages are achieved by the process for making chopped or creamed garlic according to this invention, which is characterized by the annexed claims.

### DISCLOSURE OF THE INVENTION

As mentioned above, the basic problem in making a garlic cream is to:
Maintain the organoleptic properties of the basic component, i.e. garlic,
have a garlic cream-like appearance, i.e. substantially the same color, without using any heat treatment or bleaching additives such as potassium metabisulphite.

The invention will now be described by way of a specific, non-limiting illustrative embodiment.

### First Embodiment

The following percentages shall be intended by weight based on the total weight of the ingredients.

Starting from the bulbs of garlic, the first step consists in separating them into cloves, followed by peeling.

The sprout in the cloves must not exceed 40% the length of the clove.

The creamed/chopped product is obtained by adding at least vegetable oil, salt and citric acid (E 300).

Exemplary proportion of ingredients:
Garlic 55%
Oil 40%
Salt 4%
Citric acid 1%

Citric acid is widely present in plants and is a metabolic product of all aerobic organisms. For instance, 5-7% citric acid is contained in lemon juice, but it is also present in almost any fruit, in woods, mushrooms, tobacco, wine and even milk.

Once the ingredients have been selected in the required amounts, they are mixed together to obtain a compound having the desired consistency, in case of a creamed product, or the desired particle size, in case of a chopped product.

Color is maintained by ensuring a balance of these ingredients, as long as the cloves contain a small sprout or no sprout at all.

The creamed/chopped product is obtained by an entirely cold process, i.e. with no pasteurization heat treatment, which avoids deactivation of garlic enzymes and preserves organoleptic properties.

### Second Embodiment

A second exemplary recipe involves the addition of further acidifiers in addition to the above mentioned ingredients, i.e. garlic, oil, salt and <1% citric acid.

An exemplary additive is malic acid (E 296) amounting to less than 1%; L-malic acid is a chiral carboxylic acid that can be found in wine, where it is one of the major constituents ensuring fixed acidity. As it is, it imparts unpleasant tastes: it is an unstable acid, and may be easily degraded, by malolactic fermentation, to lactic acid, which is less harsh and attenuates the aggressiveness of wine.

However, in combination with the present ingredients, it can impart a pleasant fruity taste to the creamed/chopped garlic.

As mentioned above, the total proportions will be:
Garlic 55%
Oil 40%
Salt 4%
Citric acid 0.4%
Malic acid 0.6%

Once the above ingredients have been mixed, the creamed/chopped garlic will be ready for use, no heat treatment being required.

The compound so obtained will be stable for twenty-four month storage, once it has been sealed in its package.

The two embodiments are merely illustrative of the possible embodiments that have been mentioned to define the components to be used and their proportions in the recipe.

The recipe for preparing the creamed/chopped garlic product will generally include:
Garlic 40-75%
Vegetable oil 20-55%
Salt 2-6%
Citric acid 0.7-1.5%

1. A process for obtaining chopped or creamed garlic, characterized in that it includes the steps of:
a. Separating the bulbs of garlic into cloves
b. Peeling the cloves and checking the sprout in the cloves; said sprout being less than 40% the length of the clove
c. Mixing and chopping with vegetable oil, salt and citric acid
said process being a cold process, and involving no application of heat by pasteurization or boiling or heating of the garlic or the mixture so obtained.

2. A process as claimed in claim 1, characterized in that it involves further addition of malic acid during ingredient blending.

3. Creamed or chopped garlic obtained by the process as claimed in claim 1, characterized in that, based on the total weight of ingredients, it comprises at least:
a. More than 40% garlic
b. 55% vegetable oil or less
c. 2 to 6% salt
d. 0.7 to 1.5% citric acid

4. Creamed or chopped garlic obtained by the process as claimed in claim 2, characterized in that, based on the total weight of ingredients, it comprises at least:
a. More than 40% garlic
b. 55% vegetable oil or less
c. 2 to 6% salt
d. 0.2 to 0.5% citric acid
e. 0.5 to 1.0% malic acid

5. Creamed or chopped garlic as claimed in claim 4, characterized in that the sprout in the peeled garlic clove is less than 40% the length of the clove.
